(19) United States
(12) Patent Application Publication
(10) Pub. No.: US 2025/0144575 A1
(43) Pub. Date: May 8, 2025

(54) CARBON MOLECULAR SIEVES MEMBRANES WITH ATOMIC ALUMINUM DISTRIBUTED IN IT

(71) Applicants: FUNDACION TECNALIA RESEARCH & INNOVATION, DERIO - BIZKAIA (ES); EINDHOVEN UNIVERSITY OF TECHNOLOGY, MB EINDHOVEN (NL)

(72) Inventors: MARGOT ANABELL LLOSA TANCO, DONOSTIA-SAN SEBASTIÁN (ES); DAVID ALFREDO PACHECO TANAKA, DONOSTIA-SAN SEBASTIÁN (ES); ARASH RAHIMALIMAMAGHANI, MB EINDHOVEN (NL); FAUSTO GALLUCCI, MB EINDHOVEN (NL)

(21) Appl. No.: 18/838,087

(22) PCT Filed: Feb. 13, 2023
(86) PCT No.: PCT/EP2023/053459

§ 371 Date: Aug. 13, 2024

(30) Foreign Application Priority Data
Feb. 14, 2022 (EP) 22382118.2

(51) Int. Cl. B01D 71/02; B01D 53/22; B01D 67/00; B01D 69/02; B01D 69/10; C01B 3/50

(52) U.S. Cl. CPC B01D 71/021; B01D 53/228; B01D 67/0067; B01D 69/02; B01D 69/108; C01B 3/503; B01D 2256/16; B01D 2257/102; B01D 2257/504; B01D 2257/7025; B01D 2323/081; B01D 2325/02831; C01B 2203/0405

(57) ABSTRACT

A supported carbon molecular sieve membrane having aluminum atomically distributed in it, wherein: the aluminum is present in an amount of equal to or lower than 15 wt. % of the carbon molecular sieve membrane; the membrane comprises a pore size distribution in which at least 70% of the pores have a pore size from 0.25 to 0.7 nm; and which is obtainable by dip-coating a support with a solution comprising a phenolic-resin and aluminum ions, followed by carbonization. The carbon content of the carbon molecular sieve membrane is from 75 wt. % to 95 wt. %, the oxygen content is from 2.5 wt. % to 8 wt. %, and the hydrogen content is from 1.5 wt. % to 6% wt. %. These CMSMs are useful for gas separation, H₂ recovery from natural gas grids, H₂ production from biomass, solvent dehydration, obtaining oxygen-enriched air, or dehydrogenation of methylcyclohexane, and as a catalytic membrane reactor or part of a catalytic membrane reactor.

This application claims the benefit of European Patent Application EP22382118 filed Feb. 14, 2022.

### TECHNICAL FIELD

The present invention relates to carbon molecular sieve membranes (CMSMs) with atomic aluminum incorporated therein and their uses in gas separation, for solvent dehydration, or as a membrane reactor.

### BACKGROUND ART

Hydrogen is used as feedstock in different industrial applications, such as refineries, ammonia synthesis, and methanol production, and recently is used as energy carrier in the transport sector, for power generation and heating solutions. As consequence of the increase of CO₂ in the atmosphere, hydrogen is considered a sustainable energy carrier that can enable the much needed shift from fossil to renewable-based energy sources and it is an important piece to reach net zero emissions by 2050. Besides its high energy density, the abundance of resources and zero carbon emission reaction to produce energy are considered the advantages of hydrogen compared to fossil-based fuels.

Hydrogen (H₂) can be produced by water hydrolysis, coal gasification, and steam reforming from natural gas, although the latter is still the dominant pathway. Separation and purification of hydrogen in the production process or from industrial waste streams is still one of the main challenges in the field. Known technologies for hydrogen purification include pressure swing adsorption, cryogenic distillation, and membranes separation. While membrane separation is a scalable and low energy demanding technology which can produce high purity hydrogen, the membranes need to exhibit high hydrogen permeation and selectivity, long-term stability under separation conditions, and low cost in order to be competitive to the traditional purification technologies.

Among the membranes for hydrogen separation, Palladium (Pd) based membranes exhibit the highest hydrogen permeance and selectivity due to their unique mechanism of hydrogen permeation. Unfortunately, Pd is a precious metal, and its stability decreases at low temperatures due to hydrogen embrittlement which can destroy the membrane. As a result, permeation must be conducted at temperatures above 300° C., generally around 400° C. In addition, Pd membranes can be poisoned by H₂S gas existing in the process streams as impurities.

Microporous membranes (zeolite, silica, and carbon molecular sieve) are used to separate hydrogen based on size exclusion. However, defect free zeolite membranes are difficult to prepare, and silica membranes are not stable at high temperatures in presence of water.

Carbon molecular sieves membranes (CMSMs) are one of the promising alternatives to purify hydrogen in an industrial scale. CMSMs are product of the pyrolysis of a thermosetting polymer in a non-oxidant atmosphere. The resulted amorphous carbon structure contains micro and ultra-micro pores which are responsible for the separation of the gases by molecular sieving (size separation) and adsorption diffusion (through the interaction of the gas molecule with the pore wall). They are produced from low-cost materials and can separate gases at room temperature. For mixtures where H₂ is present at low concentrations (<10%) and operating at high pressures, CMSMs can surpass the permeation performance of Pd membranes.

It is known that the polymer precursors used for the preparation of the CMSMs, the carbonization procedure, as well as their composition, influence the membrane properties and thereby its permeation performance. Thus, for instance, M. A. Llosa et al., disclosed the preparation of supported composite alumina-CMSM (Al-CMSM) prepared from Novolac phenolic resin and boehmite (γ-AlO(OH) nanosheets improving their hydrophilicity. The authors reported that the pore size and pore size distribution of the pores were tuned by changing the temperature of carbonization of the membrane and the hydrophilicity was tuned by the addition of the boehmite (see M.A. Llosa et al., “Composite-alumina-carbon molecular sieve membranes prepared from Novolac resin and boehmite. Part I: Preparation, characterization and gas permeation studies”, Int. J. Hydrogen Energy. 2015, vol. 40, pp. 5653-5663; and M.A. Llosa et al., “Composite-alumina-carbon molecular sieve membranes prepared from Novolac resin and boehmite. Part II: Effect of the carbonization temperature on the gas permeation properties”, Int. J. Hydrogen Energy. 2015, Vol. 40, pp. 3485-3496). The pore sizes disclosed for the CMSM in these publications were around 0.3-0.8 nm.

It is also known that the pore size and the hydrophilicity can also be tuned towards the optimization of the water permeation. Thus, WO2021/116319A9 discloses Al-CMSM pretreated with water vapor and its use in gas separation processes, solvent dehydration, and as membrane reactors.

Furthermore, the addition of metals into CMSMs have been disclosed for a variety of purposes. Thus, for instance, U.S. Pat. No. 10,112,149B2 discloses a method for aging-resistant carbon molecular sieve hollow fiber membranes having enhanced selectivity using metallopolyimide as precursor. The method is based on first immobilized metal cations in a polyimide hollow fiber membrane via interaction of the metals with the electronegative regions of the polyimide backbone. The metal cation used is a transition metal. In this way, the spacing in between adjacent carbon chains and/or sheet remains at about a same value avoiding the tendency to decrease the spacing between adjacent carbon chains and/or sheets in the freshly produce metallo-CMS membrane that do not sandwich cations. Thus, this document pursues the physical separation to avoid the intrinsic collapse of carbon chains (layers).

WO2019/089087 discloses a carbon molecular sieve membrane (hollow fiber or thin film) for separation of olefins from their corresponding paraffins comprising a group 13 metal, in particular Aluminum. The membrane is made by pyrolyzing a precursor polymer (polyimide) that has a group 13 metal incorporated into it, where the metal is in a reduced state (covalently bonded to carbon or nitrogen or in the metal state).

On the other hand, the separation of hydrogen present in a mixture of gases is of great interest for the foreseeing hydrogen economy and due to the growing interest in hydrogen as energy carrier. It is also of great interest, the development of CMSM reactors, i.e., devices for simultaneously performing a reaction (steam reforming, dry reforming, auto-thermal reforming, methanol synthesis, etc.) and a membrane-based separation in the same physical device. These membrane reactors allow improving processes, catalysts and adsorbents, for instance, to increase the efficiency of fuel and petrochemical production, which is highly dependent on the separation processes. The continuous extraction of one of the products can shift the equilibrium, enhancing yield and selectivity as compared with a traditional system. Besides, highly concentrated, and anhydrous solvents are of foremost importance in chemical industry. In this context, hydrophilic carbon molecular sieves membranes are also particularly good candidates to develop efficient dehydration processes.

Thus, from what is known in the state of the art, there is still the need to provide CMSMs with increase selectivity and permeation properties for the efficient purification of hydrogen from gaseous mixtures, and for better efficiencies when used as membrane reactors or for solvent dehydration.

### SUMMARY OF INVENTION

The inventors of the present invention have developed a supported carbon molecular sieves membrane (CMSM) by dip a porous support on a dipping solution containing a mixture of phenol formaldehyde resin and aluminum ion in the form of salt or complex add as carbon and aluminum precursors respectively, dry and carbonization, resulting in a CMSM in which aluminum in atomic state is uniformly distributed. The inventors have found that the incorporation of aluminum in atomic state to the CMSM provides a supported carbon molecular sieve membrane with a smaller pore diameter in the microporous region (<2 nm) than the ones of known CMSMs prepared from a phenol formaldehyde resin with and without the addition of boehmite. Boehmite is a polymer of hydroxo aluminum. Nanoparticles of boehmite have a size of around 10 nm. By being able of incorporating aluminum in atomic state using phenolic resins, the inventors not only have achieved a smaller pore diameter but a uniform narrow pore size distribution in the whole membrane, and a stable porous structure.

Advantageously, the incorporation to the CMSM of aluminum in atomic state highly increases the hydrophilicity of the membrane. Furthermore, the CMSMs have permeation properties well above the Robeson upper limit. In addition, due to the single selective layer, although they could be present, there is no requirement for additional layers to increase the selectivity.

Accordingly, the CMSMs of the present invention shows an attractive combination of high permeability due to the high porosity, selectivity, and chemical stability at high pressures and temperatures, even in the long-term performance, which makes these CMSMs especially useful for industrial gas separations such as hydrogen separation. Furthermore, the permeation can be carried out at ambient temperature, or it can be carried out at lower temperatures, up to around −50° C. Besides, they are prepared from very cheap precursors.

Thus, a first aspect of the present invention relates to a supported carbon molecular sieve membrane having aluminum atomically distributed in it, which means that the aluminum is incorporated in the carbon molecular sieve membrane in the form of single atom, wherein: the aluminum is present in an amount equal to or lower than 15 wt. % of the carbon molecular sieve membrane; the membrane comprises a pore size distribution in which at least 70% of the pores have a pore size from 0.25 to 0.7 nm measured by perm-porosimetry; the carbon content is from 75 wt. % to 95 wt. %, the oxygen content is from 2.5 wt. % to 8 wt. %, and the hydrogen content is from 1.5 wt. % to 6% wt. %; and which is obtainable by dip-coating a support with a solution comprising a phenol formaldehyde-resin and aluminum ions in the form of an appropriate salt or complex as metal precursor, followed by carbonization, wherein the appropriate salt or complex has an organic anion or an organic neutral ligand.

The content of Al is determined by Microwave Plasma Atomic Emission Spectroscopy (MP-AES) (see examples section). The-average pore size and the pore size distribution is measured by Perm-porosimetry (see examples section for the measurement methodology). There are other methods that can be used such as CO₂ adsorption (see the pore size characterization section of M.A. Llosa et al., “Composite-alumina-carbon molecular sieve membranes prepared from Novolac resin and boehmite. Part II: Effect of the carbonization temperature on the gas permeation properties”, Int. J. Hydrogen Energy. 2015, Vol. 40, pp. 3485-3496).

A second aspect of the present invention relates to a process for the preparation of a supported carbon molecular sieve membrane as defined above, comprising: a) providing a porous support; b) providing a coating solution comprising a phenol formaldehyde resin as carbon precursor, a non-aqueous solvent, formaldehyde, an acid which acts as catalyst, and aluminum ion in the form of an appropriate salt or complex as metal precursor; c) dipping at least once the porous alumina support in the solution of step b); d) optionally, drying the coated support bearing aluminum of step c); e) heating the dried support of step d) to a final pyrolysis temperature and non-oxidizing atmosphere sufficient to form the supported carbon sieve membrane containing the aluminum atomically distributed in it; f) cooling the supported carbon sieve membrane of step e) to room temperature, and wherein the appropriate salt or complex has an organic anion or an organic neutral ligand.

A third aspect of the present invention relates to a process for the separation of a gas molecule which is H₂ from a gas mixture of the gas molecule and at least one other gas molecule, the process comprising: a) providing a supported carbon molecular sieve membrane as defined above; b) providing a gas mixture comprising at least two gases; and c) feeding the gas mixture to the supported carbon molecular sieve membrane at a temperature from −80° C. to 300° C. in order to get a retentate stream having a decreased concentration of the gas molecule and a permeate stream having an increased concentration of the gas molecule.

A fourth aspect of the present invention relates to the use of a supported CMSM as defined above, for solvent dehydration.

A final aspect of the present invention relates to the use of a supported CMSM as defined above as a catalytic membrane reactor or part of a catalytic membrane reactor.

### BRIEF DESCRIPTION OF DRAWINGS

FIG. 1A shows a schematic of gas permeation setup.

FIG. 1B is a schematic of perm-porosimeter designed to measure the pore size in tubular CMSMs with water and N₂ as adsorbate and inert gas.

FIG. 2 shows a cross section SEM image of the CMSM M0 (a) and M0.7 (b).

FIG. 3 shows the effect of Al(acac)₃ concentration in the dipping solution on the viscosity of the solution and the thickness of the CMSMs.

FIG. 4 shows a XRD spectra of the non-supported CMSM.

FIG. 5 shows water adsorption in function of the Al wt. % content in the membrane.

FIG. 6 shows the pore size distribution measured with Perm-porosimetry of the non-supported CMSMs at various Al(acac)₃ content in the dipping solution.

FIG. 7 shows the N₂ permeance vs. applied pressure on CMSMs at 45° C.

FIG. 8 shows the effect of temperature of operation on H₂/N₂ ideal selectivity of the CMSMs at 6 bar ΔP.

FIG. 9 shows a comparison of CMSMs prepared in this with polymeric membranes according to the Robeson's upper bound limit.

FIG. 10 shows the long term permeation H₂ and H₂/N₂ test of M4 CMSM at 150° C. and 6 bar ΔP.

FIG. 11 shows SEM-EDX analysis of Al, C and O.

FIG. 12 shows N₂ permeance in function of the temperature of permeation of CMSM having various Al(acac)₃ content. ΔP 6 bar.

FIG. 13 shows H₂ permeance in function of the temperature of permeation of CMSM having various Al(acac)₃ content. ΔP 6 bar.

FIG. 14 shows N₂ permeability in function of the temperature of permeation of CMSM having various Al(acac)₃ content. ΔP 6 bar.

FIG. 15 shows H₂ permeability in function of the temperature of permeation of CMSM having various Al(acac)₃ content. ΔP 6 bar.

### DETAILED DESCRIPTION OF THE INVENTION

All terms as used herein in this application, unless otherwise stated, shall be understood in their ordinary meaning as known in the art. Other more specific definitions terms as used in the present application are as set forth below and are intended to apply uniformly throughout the specification and claims unless an otherwise expressly set out definition provides a broader definition.

The term “phenol formaldehyde resin” and the term “phenolic resin” have been used herein as synonym terms.

The terms “pore size” as used herein refer to the average pore diameter and is measured by Perm-porosimetry. This technique measures the average active pore size in the CMSMs.

The term “aluminum atomic-carbon molecular sieve membrane” or “Ala-CMSM” as used herein refers to a carbon membrane with aluminum in atomic form dispersed in the carbon matrix.

The expression “aluminum atomically distributed in the CMSM” means that the aluminum is incorporated in the CMSM in the form of single atom. It can form a complex with the OH groups of the phenolic resin behaving as a metal chelating crosslinker.

The term “permeation flow” is defined as the volume of the gas passing through the membrane per unit time. This value is determined experimentally with a flow meter.

The term “permeation flux” is defined as the volume flowing through the membrane per unit area per unit time. This value is calculated from the “permeation flow” divided by the membrane's area.

The term “permeance” is defined as the volume of the feed gas passing through a unit area of membrane at unit time and under unit pressure gradient, the common unit used in CMSM is mol·m⁻² s⁻¹·Pa⁻¹. This value is calculated from the “permeation flux” divided by the difference of pressure between the retentate and permeate.

The term “permeability” is defined as the transport flux of material through the membrane per unit driving force per unit membrane thickness.

The term “perm-selectivity” or ideal selectivity related to a gas refers to the ratio of the permeance of two single gases at the same temperature.

The term “pressure difference” refers to the difference of the gas pressure in the retentate and the gas pressure in the permeate.

The term “partial pressure difference” for a given gas refers to the difference of the gas partial pressure in the retentate and the gas partial pressure in the permeate.

The term “room temperature” refers to a temperature of about 20° C. to about 25° C.

The term “atmospheric pressure” as used herein is intended to refer to an atmospheric pressure at substantially 101.3 kPa (i.e., 760 mm Hg)+15 kPa.

The term “pyrolysis” and the term “carbonization” have been used herein indistinctively.

The supported carbon molecular sieve membrane of the present invention has a support and a carbon molecular sieve membrane which can also be named as carbon selective layer.

It is noted that, as used in this specification and the appended claims, the singular forms “a”, “an”, and “the” include plural referents unless the context clearly dictates otherwise.

As mentioned above, a supported carbon molecular sieve membrane having aluminum atomically distributed in it, wherein: the aluminum is present in an amount equal to or lower than 15 wt. % of the carbon molecular sieve membrane; the membrane comprises a pore size distribution in which at least 70% of the pores have a pore size from 0.25 to 0.7 nm; and which is obtainable by dip-coating a support with a solution comprising a phenolic-resin and aluminum ions, followed by carbonization. The pore size distribution is measured using Perm-porosimetry.

An appropriate aluminum salt is that that can be dissolved in an organic solvent which is used in the dipping solution. Other anions that can be destroyed during the carbonization can also be used. In a particular embodiment, the anion of the aluminum salt is an organic anion. In a particular embodiment, the aluminum salt used is aluminum acetylacetonate.

The use of aluminum acetylacetonate is advantageous because is soluble in organic solvents and stable.

The use of aluminum in the form of a complex is also advantageous because its stability and favors that it remains as single atom until the ligand exchanges with the OH groups of the phenolic resin. The ligand in the complex may be an organic anion or an organic neutral ligand. Examples of organic neutral ligands are amines such as ethylenediamine or diethyletriamine. Further examples of aluminum complexes are 8-hdroxyquinoline complex; alizarine complex; salophen complexes; acetic acid, (ethylenedinitrilo)tetra-, aluminum (III) complex; and mixed ligand complexes of Al(III) with o-nitrophenol, 1-nitroso-2-naphtol, 2,4-dinitrophenol, 8-hydroxyquinoline, 2,4,6-trinitrophenol, or o-nitrobenzoic acid, and ethylendiamine.

In a particular embodiment, the supported carbon molecular sieve membrane of the present invention (Ala-CMSM) is that where the aluminum is present in an amount of 0.1 wt. % to 11 wt. % of the carbon molecular sieve membrane. In another particular embodiment, the supported carbon molecular sieve membrane of the present invention is that where the aluminum is present in an amount of 1 wt. % to 11 wt. % of the carbon molecular sieve membrane. In another particular embodiment, the supported carbon molecular sieve membrane of the present invention is that where the aluminum is present in an amount of 3 wt. % to 10.5 wt. % of the carbon molecular sieve membrane. In a particular embodiment, the supported carbon molecular sieve membrane of the present invention is that where the aluminum is present in an amount of 4 wt. % to 9 wt. % of the carbon molecular sieve membrane. In another particular embodiment, the supported carbon molecular sieve membrane of the present invention is that where the aluminum is present in an amount of 8 wt. %-9 wt. % of the carbon molecular sieve membrane. In another particular embodiment, the supported carbon molecular sieve membrane of the present invention is that where the aluminum is present in an amount of 1 wt. % to 9 wt. % of the carbon molecular sieve membrane.

In another particular embodiment, the supported carbon molecular sieve membrane of the present invention is that where the carbon content of the carbon molecular sieve membrane is from 75 to 95 wt. %, the oxygen content is from 2.5 to 8 wt. %, and the hydrogen content is from 1.5 to 6% wt. %. The content of C, H, and O are as determined using a Thermo Scientific, Flash smart-CHNS/O analyser.

A SEM-EDX analysis of a CMSM membrane according to the invention confirms that Al, C, and O are well distributed in the membrane. It is believed that Al(III) forms a complex with the OH groups of the phenolic resin behaving as a metal chelating crosslinker. The complex formation together with the increase of viscosity of the dipping solution used to prepare the membranes which is due to the formation of complexes, hinder the movement of Al(III) avoiding the formation of poly aluminum compounds such such as alumina (Al₂O₃) and boehmite (γ-AlO(OH). This is confirmed by the XRD spectra of samples of CMSMS according to the invention where peaks of γ-Al₂O₃/boehmite (γ-AlO(OH) are not observed.

In a particular embodiment, optionally in combination with the embodiments above or below or particle size distribution, the pore size distribution is that in which at least 70% of the pores are equal to or below 0.7 nm, preferably, between 0.25 and 0.7 nm. In another particular embodiment, the pore size distribution is that in which at least 75% of the pores are equal to or below 0.7 nm, i.e., have a pore size equal to or below 0.7 nm, preferably, between 0.25 and 0.7 nm. In another particular embodiment, the pore size distribution is that in which at least 80% of the pores are equal to or below 0.7 nm, preferably, between 0.25 and 0.7 nm. In another particular embodiment, the pore size distribution is that in which at least 85% of the pores are equal to or below 0.7 nm, preferably, between 0.25 and 0.7 nm. In another particular embodiment, the pore size distribution is that in which at least 90% of the pores are equal to or below 0.7 nm, preferably, between 0.25 and 0.7 nm. In another particular embodiment, the pore size distribution is that in which at least 95% of the pores are equal to or below 0.7 nm, preferably, between 0.25 and 0.7 nm. In another particular embodiment, the pore size distribution is that in which 100% of the pores are equal to or below 0.7 nm, preferably, between 0.25 and 0.7 nm. All the percentages for expressing the pore size distribution indicated above are expressed as percentage of number of pores.

In another particular embodiment, optionally in combination with the embodiments above and/or below of particle size distribution, the pore size distribution is that in which at least 60% of the pores are equal to or below 0.6 nm, i.e., have a pore size equal to or below 0.6 nm, preferably, between 0.25 and 0.6 nm. In another particular embodiment, the pore size distribution is that in which at least 65% of the pores are equal to or below 0.6 nm, preferably, between 0.25 and 0.6 nm. In another particular embodiment, the pore size distribution is that in which at least 80% of the pores are equal to or below 0.6 nm, preferably, between 0.25 and 0.6 nm. In another particular embodiment, the pore size distribution is that in which at least 85% of the pores are equal to or below 0.6 nm, preferably, between 0.25 and 0.6 nm. In another particular embodiment, the pore size distribution is that in which at least 90% of the pores are equal to or below 0.6 nm, preferably, between 0.25 and 0.6 nm. In another particular embodiment, the pore size distribution is that in which at least 95% of the pores are equal to or below 0.6 nm, preferably, between 0.25 and 0.6 nm. In another particular embodiment, the pore size distribution is that in which 100% of the pores are equal to or below 0.6 nm, preferably, between 0.25 and 0.6 nm. All the percentages for expressing the pore size distribution indicated above are expressed as percentage of number of pores.

In another particular embodiment, optionally in combination with any of the embodiments above of particle size distribution, the pore size distribution is that in which at least 40% of the pores are equal to or below 0.5 nm, i.e., have a pore size below 0.5 nm, preferably, between 0.25 and 0.5 nm. In another particular embodiment, the pore size distribution is that in which at least 45% of the pores are equal to or below 0.5 nm. In another particular embodiment, the pore size distribution is that in which at least 50% of the pores are equal to or below 0.5 nm the pore size distribution is that in which at least 55% of the pores are equal to or below 0.5 nm. In another particular embodiment, the pore size distribution is that in which at least 60% of the pores are equal to or below 0.5 nm. In another particular embodiment, the pore size distribution is that in which at least 65% of the pores are equal to or below 0.5 nm. All the percentages for expressing the pore size distribution indicated above are expressed as percentage of number of pores.

In another particular embodiment, the pore size distribution is that in which at least 70% of the pores are equal to or below 0.7 nm and at least 40% of the pores are equal to or below 0.5 nm. In another particular embodiment, the pore size distribution is that in which at least 90% of the pores are equal to or below 0.7 nm and at least 50% of the pores are equal to or below 0.5 nm. In another particular embodiment, the pore size distribution is that in which 100% of the pores are equal to or below 0.7 nm and 55% of the pores are equal to or below 0.5 nm. In another particular embodiment, the pore size distribution is that in which 100% of the pores are equal to or below 0.7 nm and at least 65% of the pores are equal to or below 0.5 nm. Preferred ranges are those mentioned above in which the low part of the range is 0.25 nm, and the upper part of the ranges is the end points indicated for the ranges mentioned above. All the percentages for expressing the pore size distribution indicated above are expressed as percentage of number of pores.

In a particular embodiment, the supported carbon molecular sieve membrane is that were the support is a porous ceramic support which is an inorganic, non-metallic solid, based on an oxide, nitride, boride, or carbide, preferably selected from the group of alpha alumina, titanium oxide, zirconium oxide, ceria, and gamma alumina. In another particular embodiment, the supported carbon molecular sieve membrane is that were the support is a porous carbon support.

In another particular embodiment, the supported carbon molecular sieve membrane is that where the support is a porous alumina support.

In a particular embodiment, the supported carbon molecular sieve membrane is that which has a shape that can be tubular, hollow fiber, or planar.

In a particular embodiment, the supported CMSM of the present invention comprises a single selective layer on the outer surface of the porous support.

The thickness of the CMSMs of the present invention depends on the pore size of the support just below the carbon layer. As a way of example, CMSMs according to the present invention with thickness of 20 nm can be prepared if the pore size of the porous support is 5 nm without defects.

The thickness of the CMSM layers depend on the content of the aluminum salt or complex (Al(acac)₃) in the dipping solution, which also has influence in the pore size and pore size distribution of the membranes. For instance, when the amount of Al(acac)₃ is 0.7 wt. % in the dipping solution used to prepare the CMSM, the thickness of the membrane increases from 1.5 μm for a CMSM without aluminum to 2 μm. According to the SEM images a continuous layer without defects is deposited into the membrane.

The permeation properties of the membranes against the Al content in the membrane follows a volcano shape, where for instance, the membrane prepared with 4 w % of Al(acac)₃ dipping solution, containing 8.3% of Al in the membrane by MP-AES, has the best properties and was stable during 720 h for hydrogen at 150° C. and 6 bar pressure difference (20% H₂/80% N₂). All the CMSM have permeation properties well above the Robeson Upper limit. In a particular embodiment, the Al content is that obtained from using from 3-5 wt. % of Al(acac)₃ in the dipping solution.

In another particular embodiment, the supported carbon molecular sieve membrane of the present invention is that where the membrane has a hydrogen/nitrogen perm selectivity in the 20-350° C. range greater than 3.7.

In another particular embodiment, the supported carbon molecular sieve membrane of the present invention is that were the hydrogen permeance is beyond the Robeson upper limit plot of polymeric membranes.

In another particular embodiment, in combination with any of the aspects or embodiments above or below, the supported carbon molecular sieve membrane of the present invention is that which is absence of silica.

All the particular embodiments disclosed above for the supported carbon molecular sieve membrane, in any combination are also particular embodiments of the present invention.

The supported carbon molecular sieve membrane of the present invention can be prepared by dip coating a porous alumina support into a dipping solution. The process comprises: a) providing a porous support; b) providing a coating solution comprising a phenol formaldehyde resin as carbon precursor, a non-aqueous solvent, formaldehyde, an acid, and aluminum ion in the form of an appropriate salt or complex as metal precursor; c) dipping at least once the porous alumina support in the solution of step b); d) optionally, drying the coated support bearing aluminum of step c); e) heating the dried support of step d) to a final pyrolysis temperature and non-oxidizing atmosphere sufficient to form the supported carbon sieve membrane containing the aluminum; and f) cooling the supported carbon sieve membrane of step e) to room temperature. Appropriate salts or complexes are those having an organic anion or an organic neutral ligand.

Optionally, an amine such as ethylene diamine can be added to the dipping solution.

The supported carbon molecular sieve membrane of the present invention can also be defined by its preparation process. Thus, it is part of the present invention a supported carbon molecular sieve membrane obtainable by the process defined above. All the particular embodiments disclosed above or below or combination of embodiment, both those for the CMSMs of the present invention or those for the process for their preparation are also particular embodiments or combination of embodiments for this aspect of the invention.

In a particular embodiment of the preparation process, the process is that where the support is tubular α-alumina support (α-Al₂O₃).

In another particular embodiment, the solvent has a boiling point equal to or higher than 60° C. In another particular embodiment, the solvent has a boiling point equal to or higher than 100° C. Examples of appropriate solvents are N-methyl 2-pyrrolidone, ethanol, methanol, or chloroform.

Examples of appropriate acids are carboxylic acids such as oxalic acid.

In a particular embodiment, the aluminum ion in the form of an appropriate salt or complex is in the form of a soluble salt in an organic solvent. In another particular embodiment, the aluminum ion in the form of a soluble salt or complex is aluminum acetylacetonate (Al(acac)₃).

In a particular embodiment, the phenol formaldehyde resin used in the present invention is synthetic resin. The resin can be for instance a Novolac resin. Such resin is formed between phenol and formaldehyde in acidic media. As an example, the ratio between formaldehyde/phenol can be 0.75-0.85 wt. %. The resin can also be a resol resin which is from the reaction between phenol and formaldehyde in basic media. The ratio phenol/formaldehyde in the resol resin is >1 wt %. Other phenolic resins can also be used. Further examples of appropriate resins are phenol-urea-formaldehyde, phenol-melamine-formaldehyde, dicyclopentadiene-phenol, phenol and formaldehyde derivatives such as resol-formaldehyde, hydroquinone derivatives, or polybenzoxazine.

In another particular embodiment, the process is that where the phenol formaldehyde resin is obtainable by reacting phenol with and formaldehyde in acidic media at a temperature from 80 to 110° C. The acidic media may be for instance provided by an acid such as oxalic acid.

Phenolic resins, such as Novolac resin, are desirable precursors to prepare CMSMs, since they present the advantage of being inexpensive and possess high carbon yield, withstanding elevated temperatures without losing their shape. Phenolic resins are the product of the poly-condensation reaction of phenol with formaldehyde; their structure and properties depend on the formaldehyde/phenol ratio (F/P), catalyst, pH and temperature. Novolac resins are obtained in acidic media and the amount of formaldehyde is usually with an F/P of ca. 0.75-0.85.

Generally, the amount of Novolac in the coating solution is from 5 to 25 wt. %, preferably 20 wt. %; the amount of N-methyl-2-pyrrolidone is from 70 to 85 wt. %, preferably 78 wt. %, the amount of formaldehyde is from 0.5 to 5 wt. %, preferably 1.6 wt. %, and the amount of oxalic acid is from 0.1-1 wt. %, preferably, 0.4 wt. %.

In a particular embodiment, the amount of aluminum salt or complex, in particular of Al(acac)₃, in the dipping solution is from 0.5 to 6 wt. %. In a particular embodiment, the amount is from 2 to 5 wt. %.

In a particular embodiment, the aluminum salt is Aluminum acetylacetonate (Al(acac)₃). Generally, the amount of Al(acac)₃ is from 0.5 to 6 wt. % of the dipping solution. In a particular embodiment, the amount of Al(acac)₃ is from 2 to 5 wt. %. In another particular embodiment, the amount of Al(acac)₃ is 4 wt. %. A supported carbon molecular sieve membrane according to the present invention prepared with 4 wt. % of Al(acac)₃ in the dipping solution shows excellent properties and is stable during 720 hours for hydrogen at 150° C. and 6 bar pressure difference.

The treatment of immersing the porous alumina support in the dipping solution is repeated 1 to 10 times. In a particular embodiment, the process is that where the dipping step is carried out only once. In another particular embodiment, the process is that where the dipping step is repeated between 2-6 times. In another particular embodiment, the process is that where the dipping step is repeated between 3-5 times. In another particular embodiment, the process is that where the dipping step is repeated 5 times.

This treatment is generally carried out at room temperature for an appropriate time. An appropriate time can be 5-120 seconds. Generally, it is sufficient to maintain porous alumina support in the dipping solution for 5-120 seconds, in particular around 30 s. Generally, it is carried out under agitation, for example, at a speed of 5 mm/s. The dipping coating is generally repeated several times with an interval that can be for instance of 5 min, generally it is sufficient a time of around 10-40 s between cycles, in particular around 20 s.

In a particular embodiment, the drying step of the coated support is carried out at a temperature below the boiling point of the solvent used in the dipping solution. For instance, if N-methyl-2-pyrrolidone is used, the temperature is between 90 to 110° C. More particularly it is carried out under argon atmosphere.

In another particular embodiment, the process is that where the pyrolysis temperature is from 350° C. to 1100° C. In another particular embodiment, the process is that where the pyrolysis temperature is from 450° C. to 900° C. In another particular embodiment, the process is that where the pyrolysis temperature is from 500° C. to 700° C. In another particular embodiment, the process is that where the pyrolysis temperature is 500° C.

In another particular embodiment, the process is that where the step e) of pyrolysis is carried out under a non-oxidant atmosphere or vacuum. In another particular embodiment, the inert atmosphere is selected from the group consisting of argon atmosphere, nitrogen atmosphere, helium atmosphere, H₂ atmosphere, and NH₃ atmosphere. In another particular embodiment, the non-oxidant atmosphere is argon atmosphere. The carbonization pressure ranges from 2 mbar to 6 bars.

In a particular embodiment, the pyrolysis is carried in a tubular oven, with heating ramp 1° C./min until 500° C. and then is maintained at 500° C. for 3 h.

In a particular embodiment, the process is that where after the carbonization, the CMSMs is stored with a 100% relative humidity to stabilize the hydrophilic sites in the CMSMs. The time of storage at such relative humidity can be from a few hours to longer times such as for instance about 1 month.

All the particular embodiments disclosed above for the process, in any combination are also particular embodiments of the present invention.

The CMSM of the present invention exhibits very good gas separation capability. The CMSM of the present invention is useful for H₂ separation. Thus, it is also part of the present invention, a process for the separation of a gas molecule which is H₂ from a gas mixture of the gas molecule and at least one other gas molecule, the process comprising: a) providing a supported carbon molecular sieve membrane as defined above; b) providing a gas mixture comprising at least two gases; and c) feeding the gas mixture to the supported carbon molecular sieve membrane at a temperature from −80° C. to 300° C. in order to get a retentate stream having a decreased concentration of the gas molecule and a permeate stream having an increased concentration of the gas molecule. In a particular embodiment, the temperature at which the gas mixture is fed is from −10 to 300° C. In another particular embodiment, the temperature at which the gas mixture is fed is from 0° C. to 300° C. In another particular embodiment, the temperature at which the gas mixture is fed is from 5° C. to 250° C.

This aspect can also be defined as the use of a CMSM as defined above for the separation of a gas from a gas mixture. It can be used for example for hydrogen recovery form waste streams.

Membrane processes for gas separation are characterized by the fact that a feed stream which is a gas mixture is divided into two streams: the retentate and the permeate. The retentate is that part of the feed that does not pass through the membrane, while the permeate is that part of the feed that does pass through the membrane, i.e., the separated gas.

In a particular embodiment, step c) of the third aspect of the invention, i.e., the feeding of the gas mixture to the supported carbon molecular sieve membrane is carried out at a temperature from 5° C. to 250° C., from 5 to 120° C., from 15° C. to 120° C., from 15° C. to 100° C., from 15° C. to 70° C., or from 20° C. to 50° C., such as of 40° C. In a particular embodiment, the feeding is carried out at room temperature.

In a particular embodiment, the separation process is that where the gas mixture comprising at least two gases is selected from the group consisting of H₂/CH₄; H₂/N₂; H₂/CO₂. In a particular embodiment, the gas mixture may comprise some water, i.e. non-anhydrous. In another embodiment, the gas mixture is anhydrous.

In a particular embodiment, the CMSMs of the present invention are used for H₂ recovery from natural gas grids. The wide natural gas grid infrastructure can be used to store and distribute H₂ present in low concentration (<20%) blended with natural gas (CH₄); then, at the end users, H₂ can be separated, The CMSM of the present invention can be used for such separation. In a particular embodiment, the membrane of the present invention is used with an inlet pressure of 7.5 bar and permeated pressure of 0.01 bar at 30° C.

Purity higher than 99% can be obtained. Advantageously, the membranes of the present invention do not suffer from concentration polarization specially at high pressures and low H₂ content as occurs with other membranes such as PdAg membranes. Furthermore, no reduction in hydrogen permeance is shown between pure gas and mixture permeation tests. Sensitivity analysis show that at low concentration of H₂ and high pressure the use of the membranes of the present invention is more economic than PdAg membrane at the same recovery and similar purity even without considering the cost of carry out the permeation for the PdAg membrane at 400° C. while the membranes of the present invention can be carried out at 20° C.

In another particular embodiment, the CMSMs of the present invention are used for H₂ production from biomass. Dark fermentation (DF) is the most developed method for biohydrogen production. it has several advantages, such as low energy demand, high bacterial growth rate, minimal pollution generation, low capital costs, higher hydrogen production rate, as well as no oxygen limitation problem for small-scale productions. However, if H₂ is not well removed, H₂ is build up in the headspace of the fermented inhibiting the H₂ formation reaction occurs due to thermodynamic restrictions. The use of the CMSMs of the present invention allows the continuous and effective removal of H₂. The process is usually accompanied with by-products of CO₂, volatile organic compounds (VOC), hydrogen sulfide (H₂S), and ammonia (NH₃), producing hydrogen in the range of 35-65 vol %.

The CMSMs of the present invention suit very well for this process since they are not poisoned by H₂S, do not swell and their permeation properties are enhanced by the presence of moisture in the environment.

In another particular embodiment, the CMSM of the present invention are used in H₂/CO₂ separation. Actual efforts are to improve H₂/CO₂ separation. Unlike Pd membrane reactors that produce pure H₂ from CH₄ at 450-500° C. and are expensive, and polymeric membranes that are not stable at high temperatures, the CMSMs of the present invention are able to work at 100-300° C. range having good H₂ selectivity.

The CMSM of the present invention can also be used for oxygen-enriched air. The oxygen-enriched air is highly demanded for various industrial applications such as medical, chemical and enhanced combustion processes membrane technology and specially CMSM has a huge potential to compete with current separation techniques such as PSA and cryogenic distillation.

The supported CMSMs membranes of the present invention can also be used for other applications which also form part of the present invention.

Thus, one of these applications is the use of the supported CMSMs membranes of the present invention for solvent dehydration, i.e., for the removal of water from an organic solvent to obtain an organic solvent containing less than 1% of water, preferably, less than 0.5% of water, more preferably less than 0.1% of water. Examples of organic solvents include methanol, ethanol, propanol, n-butanol, iso-butanol, tert-butanol, acetone, dimethyl ether, dimethylcarbonate, tetrahydrofurane, acetonitrile, dioxane, acetic acid, and ethyl acetate.

In the process of solvent dehydration water gas is passed through the pores by applying vacuum from the permeated side of the membrane. Since the solvent molecules are bigger or close to the biggest pore for molecular sieving (>0.55 nm) and water is very small only water will pass. In addition, water is adsorbed preferentially in the hydrophilic pores of the AD region of pores blocking the passage of the other less hydrophilic molecules. Dipolar aprotic solvents are used in organic synthesis and in the dissolution of polymers in which, very small amount or traces of water can be detrimental.

Another application is the use of a supported CMSM as defined above as a catalytic membrane reactor. The supported CMSM of the invention have high potential because they are easier to prepare, cheaper and with better permeation properties than the zeolite membranes that are currently investigated in the field of catalytic membrane reactors, especially for the reaction of CO₂ and H₂. Also, for hydrogen production, hydrogenation chemical reactions, dehydrogenation chemical reactions, or for esterification reactions where water is produced.

The supported CMSM of the present invention can be used in process intensification for the in-situ removal of water during catalytic reactions in the chemical, petrochemical, food, cosmetics sectors. Particularly in processes for the production of methane, methanol, dimethyl ether, dimethyl carbonate (DMC), or other organic solvents, where water is produced in the reactions. Examples of processes where the supported CMSM of the invention can be used as a catalytic membrane reactor are the reaction of CO₂ and H₂ to produce CH₄; synthesis of esters by reaction of alcohols with carboxylic acids; biodiesel and bio lubricants; methanol produced from CO₂ and H₂; dimethyl ether obtained by methanol dehydration or by direct synthesis from CO₂ and H₂; and synthesis of dimethyl carbonate from CO₂ and methanol. By the use of the supported CMSM of the invention water is removed from the reaction product and the production of the compound of interest, such as of oxygenated solvents and esters.

Finally, the supported CMSM of the present invention can be used in the process of dehydrogenation of methylcyclohexane.

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention. The following examples and drawings are provided by way of illustration, and they are not intended to be limiting of the present invention. Reference signs related to drawings and placed in parentheses in a claim, are solely for attempting to increase the intelligibility of the claim and shall not be construed as limiting the scope of the claim. Furthermore, the present invention covers all possible combinations of particular and preferred embodiments described herein.

### EXAMPLES

### Materials and Methods

Formaldehyde (37% VWR chemicals), N-methyl-2-pyrrolidone (NMP, 99.5%), aluminum acetylacetonate (>98%) and phenol (>99%) from Sigma-Merck and oxalic Acid (98%) from Acros organics were used without further purification. Asymmetric tubular porous alumina with outer diameter (OD) of 10 mm and inner diameter (ID) of 7 mm with an external layer of alumina having 100 nm pore size, and length of 50 cm supplied by Inopore Gmbh. were used as support after cutting to 15 cm in length. The porous supports were connected to the dense alumina tube on one side, on the other side the supports were closed via glass sealing which required the heating of the supports to 900° C. with a heating ramp of 1.5° C./min, dwelling time of 10 minutes and cooling rate of 3° C./min.

### Example 1: Novolac Precursor Synthesis

65 g of phenol was placed inside a three neck round bottom flask equipped with a reflux condenser and heated to 50° C. for 60 min, then 1 g oxalic acid was added while mixing at 500 rpm with magnetic stirrer for 30 min; the temperature was increased to 85° C. and 46 g of formaldehyde was added dropwise in a period of 60 min. After 10 h of reaction, the solution was centrifuged three times at 4400 rpm and 10° C. to separate water and unreacted reactants. In the final step, the precursor was dried under vacuum at 50° C. and 4 mbar for 24 h. The resulted Novolac powder was used as carbon precursor in the synthesis of CMSMs.

### Example 2: Dipping Solution Preparation

20 g of the prepared Novolac was mixed with 78 g of NMP in a high shear force mixer (Thinky ARE-310) at 2000 rpm for 30 min; then, the equipment was left to rest for 10 min to prevent the overheating of the solution; this cycle was repeated 3 times. Next, 1.6 g of formaldehyde was introduced to the solution and mixed at 2000 rpm for 30 min. Then, 0.4 g of oxalic acid was added and mixed at 2000 rpm for another 30 min. This mixture was used to prepare dipping solutions with various contents of Al(acac)₃.

TABLE 1
Composition (wt. %) of the dipping solutions used for the preparation
of supported that were prepared with variation in added Al(acac)₃.

| Membrane | Novolac | Al(acac)₃ | NMP | Formaldehyde | Oxalic acid |
|---|---|---|---|---|---|
| M0 | 20 | 0 | 78 | 1.6 | 0.4 |
| M0.7 | 19.3 | 0.7 | 78 | 1.6 | 0.4 |
| M2 | 18 | 2 | 78 | 1.6 | 0.4 |
| M4 | 16 | 4 | 78 | 1.6 | 0.4 |
| M6 | 14 | 6 | 78 | 1.6 | 0.4 |

### Example 3: Preparation of the Supported CMSM. Dip Coating, Drying and Carbonization

The prepared porous alumina supports, were dipped at room temperature for 30 s with a dipping solution listed in Table 1 using a custom-made dip-coating machine and withdrawal at speed of 5 mm/s. This dipping cycle was repeated five times with an interval of 20 s between cycles. Next, the membranes were immediately moved to a rotary dryer oven where the coated supports were dried under Argon atmosphere at 140° C. for 6 hr. Then, the tubes were carbonized in a tubular oven (Nabertherm R 170/1000/12) using a heating ramp of 1° C./min until 500° C. where the temperature was kept for 3 h in a flowing argon atmosphere (100 l/h). After the carbonization, the CMSMs were stored in a humidification chamber with a 100% Relative Humidity (RH) to stabilize the hydrophilic sites in the CMSMs for one month.

### Example 4: Preparation of Non-Supported Membranes

Non-supported membranes were prepared by pouring the dipping solution in a Teflon dish and then heating in an oven at 80° C. for 24 h; the film formed was carbonized using the same conditions of the supported membranes.

### Example 5: Physicochemical Characterization

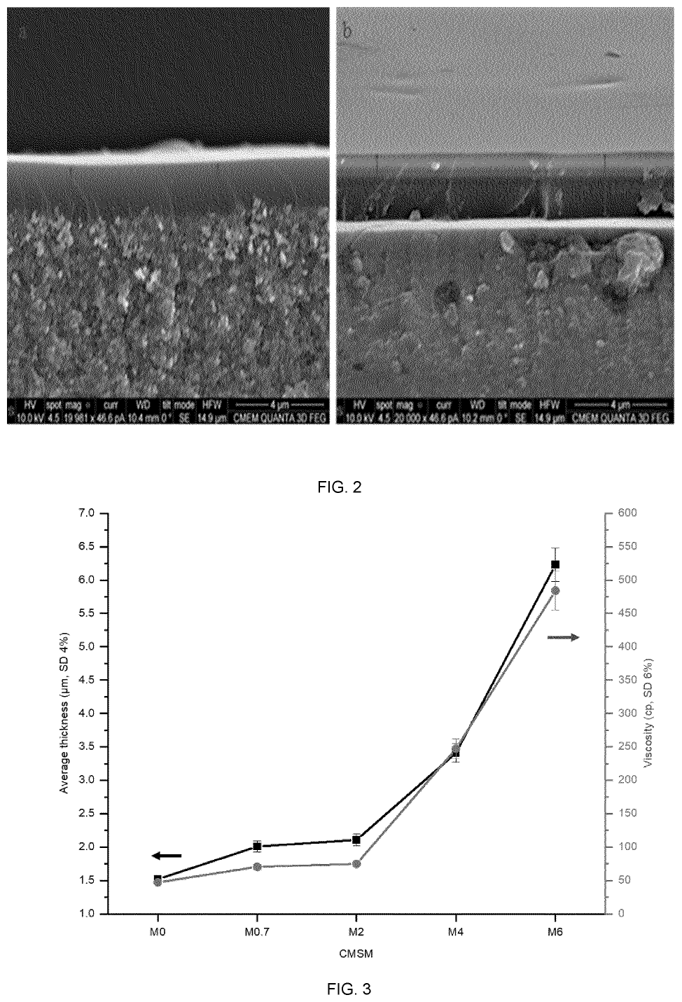

The thickness of the membranes was measured using a Scanning Electron Microscopy (SEM) Quanta 200 FEG-3D equipped with EDX (Phenom, ProX) applying a potential of 10 kV. Before analysis, the samples were sputtered (Quorum, Q150RS) with Au for 30 s and 40 mA current. The thickness reported is the average of at least 4 measurements of different sections of the membrane. SEM images of a CMSM obtained of dipping solutions without Al(acac)₃ (M0) and with 0.7 wt. % Al(acac)₃ (M0.7) are shown in FIG. 2.

It can be observed that a continuous layer ˜1.5 μm thick of carbon without defects is deposited on a porous alumina support. It was observed by SEM that the thickness of the membrane increases (˜2 μm for M0.7) with the concentration of Al(acac)₃ in the dipping solution as shown in FIG. 3. To explain this behaviour, the viscosity of the dipping solutions was measured, and the results are also plotted in the same figure.

Viscosity of the dipping solution was measured with a Brookfield, Ametek DV2T viscosimeter at 20° C.

X-ray diffraction (XRD) analysis was performed on the support free carbon films with variation of Al(acac)₃ loading in them in the 20 range of 10-120°. Ni β-filtered Cu-Kα radiant at 40 kV, 30 mA and a scan step of 0.05°/min was used with a MiniFlex 600 machine from Rigaku. The JCPDS database was used to analyse to identify the existing peaks in the spectrum.

It can be seen that the thickness of the CMSM increases with the viscosity of the dipping solution following the Landau-Levich equation (Eq. 1):

$${h}_{0} = c \frac{{( η {U}_{0} )}^{2 {/}_{3}}}{{{γ}^{1 {/}_{6}} ( ρ g )}^{1 {/}_{2}}} \qquad ( Eq . 1 )$$

Where h₀, ρ, g, U₀, η and γ are the wet film thickness, solution density, gravitational constant, withdrawal speed of the ceramic support from dipping solution, viscosity of the dipping solution and surface tension respectively. C is related to the curvature of the dynamic meniscus and could be calculated experimentally.

FIG. 3 shows the effect of Al(acac)₃ concentration in the dipping solution on the viscosity of the solution and the thickness of the CMSMs. From M0 to M2, the increase in the viscosity is small, for higher Al(acac)₃, the viscosity increases sharply, this could be due to the formation of complexes between Al(III) with the OH— groups of the phenolic resin behaving as a metal chelating crosslinker. This complex formation and the increase the viscosity of the dipping solution will hinder the movement of Al(III) avoiding the formation of poly aluminium compounds such as alumina (Al₂O₃) and boehmite (γ-AlO(OH).

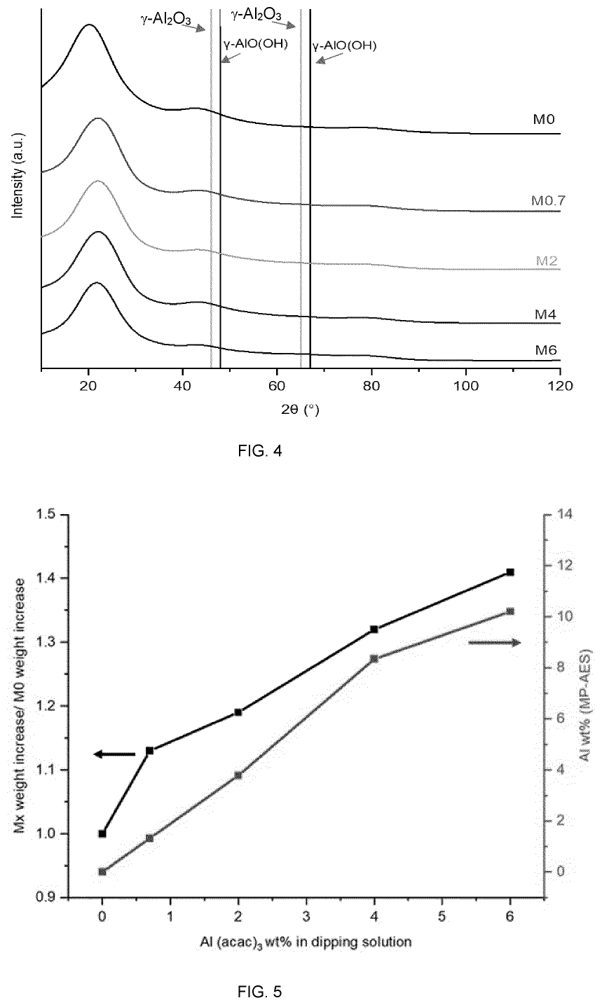

This is also seen in the XRD spectra of the samples which is presented in FIG. 4 and where the peaks of γ-Al₂O₃/boehmite (γ-AlO(OH) were not observed.

SEM-EDX analysis of M2 reveals that Al, C and O are well distributed in the membrane (FIG. 11).

The composition of the membranes was carried out using the non-supported membranes. Since the CMSM layer is very thin both a supported and non-supported CMSM membrane have very similar composition as far as they are prepared in the same conditions. C, H, and O was determined using a Thermo Scientific, Flash smart-CHNS/O analyser.

The Al content was obtained by calcination of the film at 600° C. for 3 h under air in the box oven (Nabertherm N 500/85 HA) and the ashes were dissolved in concentrated nitric acid (67 wt. %) for 24 h at 50° C., then, the samples were diluted with 5 wt. % nitric acid and the Al content determined using a Microwave Plasma Atomic Emission Spectroscopy (MP-AES) (Agilent, 4210).

C, H and O elemental composition of the membranes obtained by organic elemental analysis and SEM-EDX, and Al composition determined by MP-AES are listed in Table 2.

TABLE 2
Percentage composition (wt. %) of the CMSMs with
EDX, MP-AES and organic elemental analysis.

| | SEM-EDX ^{a} | | | MP-AES^{b} | Organic elemental analysis^{c} | | |
|---|---|---|---|---|---|---|---|
| Membrane | C | O | Al | Al | C | O | H |
| M0 | 96.38 | 3.62 | — | — | 96.04 | 2.35 | 1.61 |
| M0.7 | 94.91 | 3.45 | 1.63 | 1.32 | 93.68 | 3.02 | 1.83 |
| M2 | 91.98 | 3.71 | 4.31 | 3.78 | 90.42 | 3.59 | 2.07 |
| M4 | 84.94 | 5.61 | 9.45 | 8.34 | 82.97 | 5.24 | 3.23 |
| M6 | 80.58 | 7.26 | 12.16 | 10.2 | 77.01 | 6.98 | 4.64 |

^{a} error 9%,
^{b}error 6%,
^{c}error 4%.

C and O compositions obtained by SEM-EDX are comparable. As it is expected, the amount of oxygen in the samples increase as the Al content increase; similar trend is observed with H suggesting that the increment is caused by the presence of OH in the membrane. The presence of Al₂O₃ is discarded because of the increase of the hydrogen content and the absence of related peaks in XRD (FIG. 4). Al could be in the form of aluminium hydroxides (AlO(OH) and/or Al(OH)₃) bounded to the carbon matrix. Both compounds are hydrophilic, therefore, the hydrophilicity of the membrane should increase with the Al content in the membrane.

Water adsorption test was used to investigate the change of hydrophilicity in the pores of CMSMs, support-free CMSMs samples were weighted and left in 100% RH in a custom-made climate chamber for one week, after one week, the samples were left for 24 h at 20° C. and 30% RH to remove the bulk water on the surface of the samples in the climate chamber (Memmert HCP 50). Then, the samples were weighed again and normalized percentage of increase in weight compared to the sample without any Al(acac)₃ in the dipping solution.

The fact that hydrophilicity is increase with the Al content in the membrane is seen in FIG. 5 in which the ratio between the weight after hydration and to the dry sample in function of the Al wt. (%) present in the membrane is plotted and the relation is almost linear.

### Example 6: Permeation Characterization

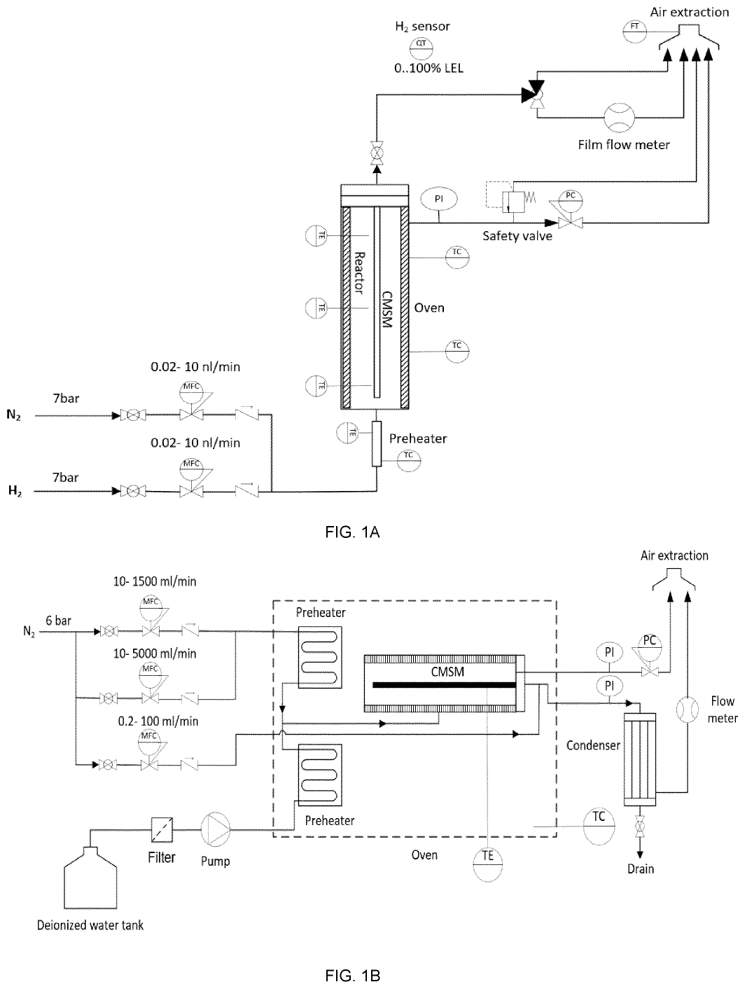

Single gas permeation tests were performed in the permeation setup shown in FIG. 1. The setup has 3 main sections, a) gas feeding, equipped with multiple mass flow controllers (MfCs). b) the tubular oven equipped with 3 thermocouples located along the membrane. c) the back pressure regulator, safety valve, and the bubble flow meter (Horiba SEC VP1 and VP3). Before permeation measurement, the CMSM was kept at N₂ atmosphere for 24 h at 45° C. and 1 bar pressure difference (between permeate and retentate streams) for stabilization. H₂ and N₂ single gas permeation measurements were carried out at various pressure differences and temperatures. The ideal H₂/N₂ selectivity (perm-selectivity) is the ratio of H₂ and N₂ flow rates at given temperature and pressure. The CMSM with the best performance in terms of H₂/N₂ perm-selectivity was tested for 720 h; at 150° C. and 6 bar pressure difference; H₂ and N₂ flux were measured every day.

### Example 7: Determination of Pore Size Distribution Using Perm-Porosimetry

This method uses capillary condensation as a tool to block the pores via adsorption of water molecules in the pores of CMSM at a certain humidity level which membrane is exposed. In pores below 2 nm, the interaction of the adsorbed molecules with each other and with the walls of the nano pores are increased due to confinement and condensation below the saturation vapor pressure. The relationship between the relative vapor saturation pressure and CMSM's pore size, is explained by the Kelvin's equation (Eq. S1)

$${r}_{p} = \frac{{v}_{m} * σ * cos ( θ )}{RTln ( \frac{P}{{P}_{s}} )} \qquad ( Eq . S1 )$$

Where rₚ, Vₘ, σ, θ, P, Pₛ, R and T are pore radius, molar volume of the condensed liquid, condensate surface tension, contact angle of the liquid with CMSM's wall, partial pressure of the condensable vapor, saturation pressure of the condensable vapor, gas constant and the temperature respectively.

The setup consists of gas feeding section, water injection system, catalytic membrane reactor, flow meter and condenser. FIG. 1B, shows a schematic of permporometry setup.

Before the perm-porosimetry test, the CMSM was heated at 400° C. for 48 h in N₂ atmosphere to remove water molecules from the pores. The pressure, temperature and N₂ feed flow rates in MFCs were set and N₂ flow rate in the permeate of the CMSM was measured with a bubble flow meter (Horiba SEC, VP1, VP2). After the stabilization of the membrane (60 min), water stream injected using a HPLC pump; after 30 min of equilibration, the N₂ permeate flowrate was measured. The flow was measured each 30 min until the difference with previous measurement was less than 5% of variation. Then, more water was injected following the described protocol until N₂ permeation was not detected. Finally, the pore size distribution has been calculated according to the decrease of the flow rate in the permeate at each step of condensable vapor injection.

### Example 8: Perm-Porosimetry Tests

The measurement of active pore size in CMSMs were performed with a custom-made (FIG. 1B) capillary condensation perm-porosimeter;

The effect of aluminum hydroxides on the pore size of the CMSMs were analysed by Perm-porosimetry.

In this method, the condensation of water in the pores gradually block them to the passage of other gases starting from the smallest to the biggest pores as the ratio of water vapor to non-condensable gas (N₂) increases. The kinetic diameter of N₂ is 0.364 nm, therefore, with this method only the pores bigger than around 0.4 nm can be measured.

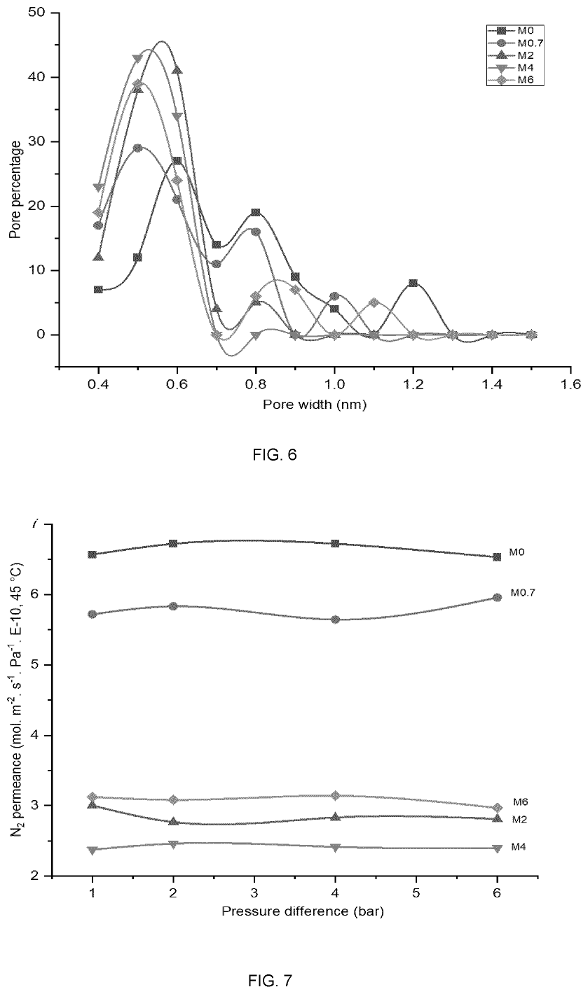

The effect of Al(acac)₃ on the pore size distribution of the CMSMs calculated by porosimetry is presented in FIG. 6 and the following table:

TABLE 3
percentage of pores (number of pores)

| CMSM | <0.5 nm (%) | <0.6 | <0.7 nm (%) |
|---|---|---|---|
| M0 | 19 | 46 | 60 |
| M0.7 | 46 | 67 | 78 |
| M2 | 50 | 91 | 95 |
| M4 | 66 | 100 | 100 |
| M6 | 58 | 82 | 82 |

CMSM, M0, which does not have Al(acac)₃, has the biggest pores; the higher percentage of pores are at around 0.72 nm, other bigger are present until 1.2 nm where no more pores are observed.

With an introduction of the Al(acac)₃ the smallest pores detected shifted to smaller pores (0.6, 0.55 and 0.49 nm for M0.7, M2 and M4 respectively). For M4, only one pick is observed showing a very narrow pore size distribution (66% of the pores are below 0.5 nm).

The predominance of smallest pores in the membrane shows a volcano shape against the addition of Al(acac)₃ which a maximum at M4.

### Example 9: CMSMs Permeation Tests

For qualitive analysis of the existence of defects in the membrane, the pores bigger than 50 nm could be considered as defects. The N₂ permeance of a CMSM can be considered to be the contribution of Knudsen (pores 2-50 nm) and viscous flow (pores >50 nm) mechanism of transport; since the flux in the micropores (<2 nm) is low the contribution can be neglected. Therefore, the observed permeance (Permobs) is the contribution of Knudsen (Permkundsen) and viscous flow (Permviscous) (eq.2)

$${Permeance}_{obs} = {Permeance}_{Knudsen} + {Permeance}_{viscous} = α + β P \qquad ( Eq . 2 )$$

Plotting the observed permeance against the pressure difference (P), a positive slope (3) indicates the presence of defects (>50 nm). FIG. 7 the results of N₂ permeances of the CMSMs vs. applied pressure difference between retentate and permeate are plotted. As it can be observed in FIG. 7, the slopes of the membranes can be considered zero which reveals that the membranes do not contain defects. The highest and the smallest permeances are for M0 and M4 respectively which agree with the pore size distribution shown in FIG. 6 where M0 has the biggest pores and M4 the smallest.

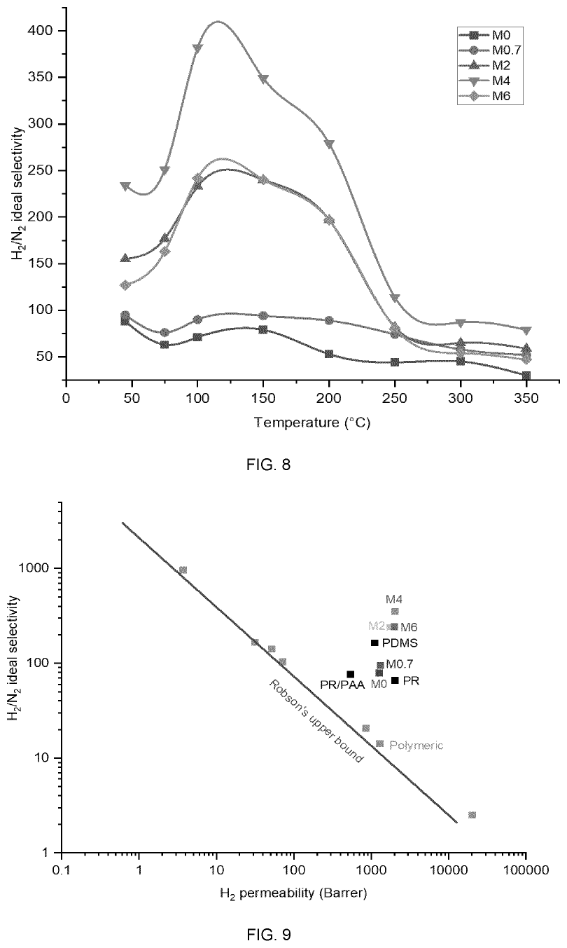

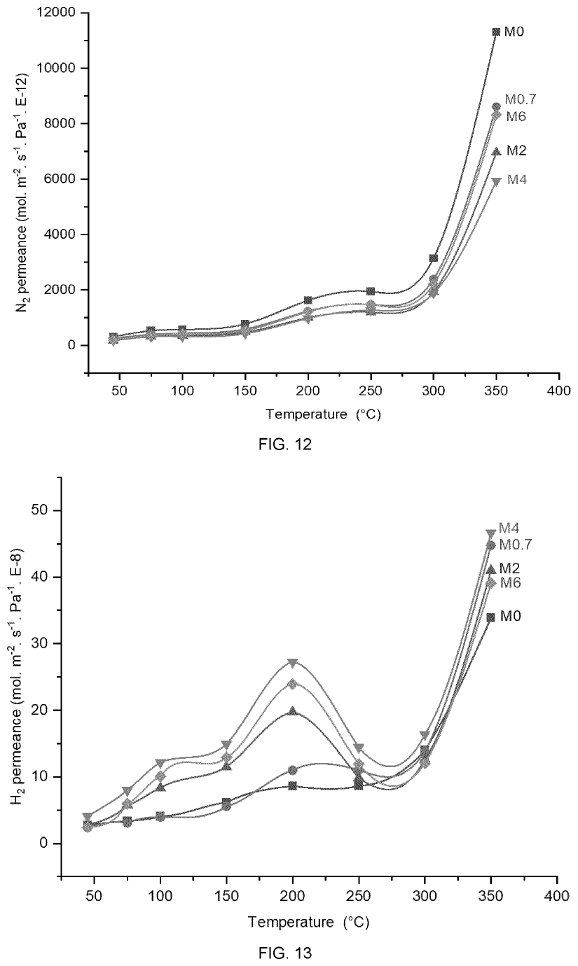

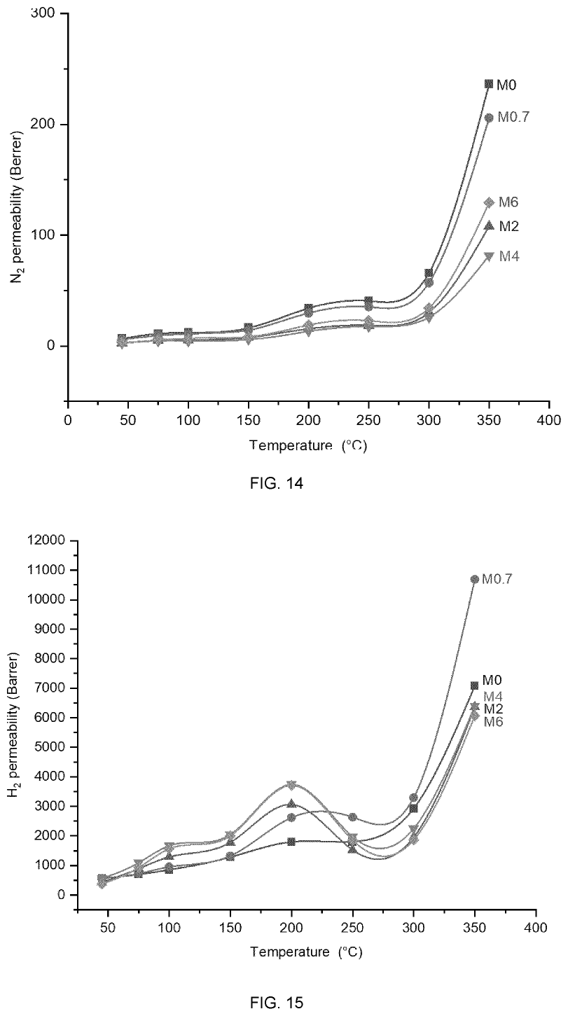

The permeation properties of membranes for hydrogen separation are hydrogen permeance and H₂/N₂ ideal selectivity at a given temperature and pressure. H₂ and N₂ permeances of the CMSMs in function of the temperature of permeation and the content of Al(acac)₃ in the dipping solution are illustrated in FIGS. 12 and 13. Since the thickness of the CMSM depends on the viscosity of the dipping solution, the permeances standardized with the thickness (permeabilities) are shown in FIGS. 14 and 15. FIG. 8 represents the H₂/N₂ ideal selectivity of CMSM at various Al(acac)₃ contents at 6 bar pressure difference in function of the temperature of permeation. M4 has the highest selectivity at all the temperatures; in general, the H₂/N₂ ideal selectivities at a given temperature follows the order M0<M0.7<M2<M6<M4 which is related to volcano shape for the smallest pore size distribution (FIG. 6) and N₂ permeance (FIG. 7).

As FIG. 8 represents, the effect of temperature and the added Al(acac)₃ on the H₂/N₂ selectivity. M4, showing the maximum ideal selectivity at all the temperatures compared to other CMSMs in the range of tests. According to H₂ and N₂ permeances (FIGS. 12 and 13), at temperatures higher than 300° C. the sharp increase in gas permeations is an indication of not stable CMSMs performance. The unstable performance is observed due to the change in the carbon matrix and as a result change in the pore size and pore size distribution which leads to the sharp decrease in H₂/N₂ ideal selectivity (FIG. 8).

The H₂/N₂ permeation performance of the CMSM of this work are compared with polymeric membranes and other carbon membrane from the literature by introducing the H₂ permeability and H₂/N₂ ideal selectivity in a Robeson plot (FIG. 9). All the CMSM of the present invention tested are well above the Robeson upper limit. In addition to polymeric membranes, CMSMs performance of the present invention are compared to the performance of CMSMs found in literature which are fabricated with Phenolic Resin (PR) (see M. Texeira et al., “Boehmite-phenolic resin carbon molecular sieve membranes-Permeation and adsorption studies” Chem. Eng. Res. Des. 2014, vol. 92, no. 11, pp. 2668-2680) or different precursors such as PR/PAA (see L. Li, C. Song, H. Jiang, J. Qiu, and T. Wang, “Preparation and gas separation performance of supported carbon membranes with ordered mesoporous carbon interlayer,” J. Memb. Sci., vol. 450, pp. 469-477, January 2014) and PDMS (see A. K. Itta, H. H. Tseng, and M. Y. Wey, “Fabrication and characterization of PPO/PVP blend carbon molecular sieve membranes for H₂/N₂ and H₂/CH₄ separation,” J. Memb. Sci., vol. 372, no. 1-2, pp. 387-395, April 2011). As the content of Al(acac)₃ increases the performance of the CMSMs enhances with reaching the maximum at M4 membrane and passing the reported values for the CMSMs in the literature.

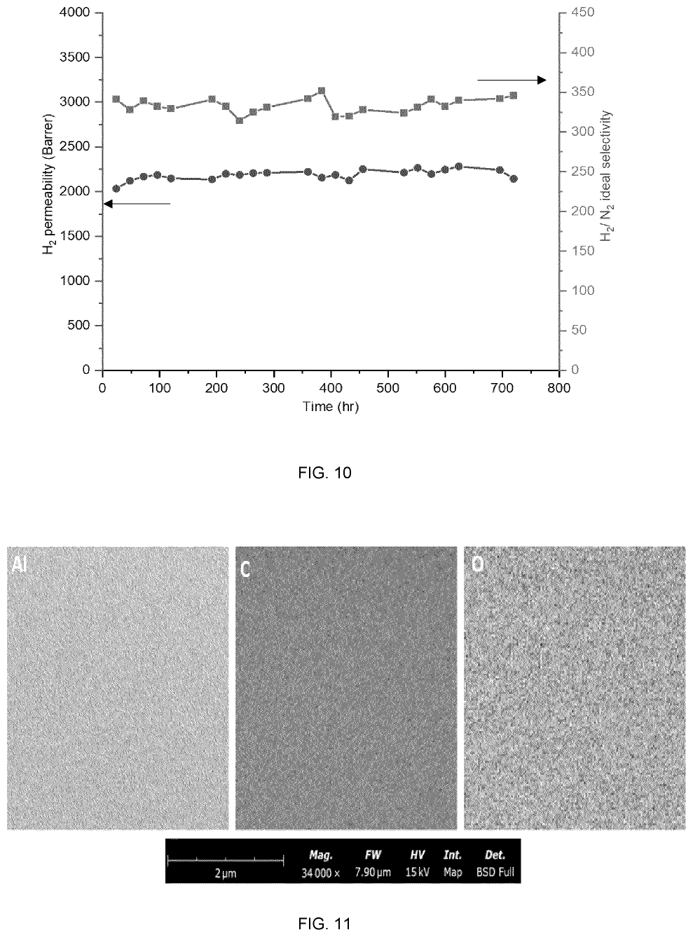

Long term stability of M4 was tested by analysing the H₂ permeance and H₂/N₂ ideal selectivity for 720 h at 150° C. and 6 bar pressure difference. FIG. 10 shows that M4 is stable during the entire test with maximum 5.7% SD variation in H₂/N₂ ideal gas selectivity and 7.04% SD variation in H₂ permeability.

In short, elemental analysis showed that the O and H content in the CMSM increases with the Al content which suggest the presence of hydrophilic aluminium compounds containing hydrophilic groups which was demonstrated by water adsorption studies. The formation of complexes of Al with the OH of the phenolic groups have influence in the pore size distribution of the membrane; M0 (without Al), has the biggest pores, and the pores became smaller with the addition of Al(acac)₃. M4 has the smallest pore with sharp pore size distribution which is reflected in the permeation properties of this membrane: it has the highest H₂/N₂ selectivity in the 50-350° C. range of temperature permeation. All the membranes prepared are well above the upper bond limit for polymeric membranes.

The M4 membrane was stable for H₂ permeation for 720 h at 150° C. and 6 bar ΔP.

### CLAUSES

Clause 1. A supported carbon molecular sieve membrane having aluminum atomically distributed in it, wherein: the aluminum is present in an amount of equal to or lower than 15 wt. % of the carbon molecular sieve membrane; the membrane comprises a pore size distribution in which at least 70% of the pores have a pore size from 0.25 to 0.7 nm; and which is obtainable by dip-coating a support with a solution comprising a phenolic-resin and aluminum ions, followed by carbonization.
Clause 2. The supported carbon molecular sieve membrane according to clause 1, wherein the membrane comprises a pore size distribution in which at least 60% of the pores have a pore size from 0.25 to 0.6 nm.
Clause 3. The supported carbon molecular sieve membrane according to any of the clause 1-2, wherein at least 85% of the pores have a pore size from 0.25 to 0.6 nm.
Clause 4. The supported carbon molecular sieve membrane according to any of the clauses 1-3, wherein the support of the carbon molecular sieve membrane is a porous alumina support.
Clause 5. The supported carbon molecular sieve membrane according to any of the clauses 1-4, wherein the phenol formaldehyde resin is a synthetic phenol formaldehyde resin.
Clause 6. The supported carbon molecular sieve membrane according to any of the clauses 1-5, wherein the aluminum ions are in the form of aluminum acetylacetonate.
Clause 7. The supported carbon molecular sieve membrane according to any of the clauses 1-6, wherein the aluminum is present in an amount of 1 wt. % to 11 wt % of the carbon molecular sieve membrane.
Clause 8. The supported carbon molecular sieve membrane according to clause 7, wherein the aluminum is present in an amount of 7 wt. % to 9 wt. % of the carbon molecular sieve.
Clause 9. The supported carbon molecular sieve membrane according to any of the clauses 7-8, wherein the carbon content is from 75 wt. % to 95 wt. %, the oxygen content is from 2.5 wt. % to 8 wt. %, and the hydrogen content is from 1.5 wt. % to 6% wt. %.
Clause 10. A process for the preparation of a supported carbon molecular sieve membrane as defined in any of the clauses 1-9, comprising:
a) providing a porous support;
b) providing a coating solution comprising a phenol formaldehyde resin as carbon precursor, a non-aqueous solvent, formaldehyde, an acid, and aluminum ion in the form of an appropriate salt or complex as metal precursor;
c) dipping at least once the porous alumina support in the solution of step b);
d) optionally, drying the coated support bearing aluminum of step c);
e) heating the dried support of step d) to a final pyrolysis temperature and non-oxidizing atmosphere sufficient to form the supported carbon sieve membrane containing the aluminum; and
f) cooling the supported carbon sieve membrane of step e) to room temperature.
Clause 11. The process according to clause 10, wherein the pyrolysis temperature is from 350° C. to 1100° C.° C. and is carried out under a non-oxidant atmosphere or vacuum.
Clause 12. A process for the separation of a gas molecule which is H₂ from a gas mixture of the gas molecule and at least one other gas molecule, the process comprising:
a) providing a supported carbon molecular sieve membrane as defined in any one of clauses 1 to 9;
b) providing a gas mixture comprising at least two gases; and
c) feeding the gas mixture to the supported carbon molecular sieve membrane at a temperature from −80° C. to 300° C. in order to get a retentate stream having a decreased concentration of the gas molecule and a permeate stream having an increased concentration of the gas molecule.
Clause 13. The process according to clause 12, wherein the gas mixture comprising at least two gases is selected from the group consisting of H₂/CH₄; H₂/N₂; H₂/CO₂.
Clause 14. Use of a supported CMSM as defined in any of the clauses 1-9, for H₂ recovery from natural gas grids, H₂ production from biomass, for solvent dehydration, for obtaining oxygen-enriched air, or for dehydrogenation of methylcyclohexane.
Clause 15. Use of a supported CMSM as defined in any of the clauses 1-9, as a catalytic membrane reactor or part of a catalytic membrane reactor.

### CITATION LIST

### Patent Literature

WO2021/116319A9;
U.S. Pat. No. 10,112,149B2;
WO2019/089087A1;

### Non Patent Literature

M.A. Llosa et al., “Composite-alumina-carbon molecular sieve membranes prepared from Novolac resin and boehmite. Part I: Preparation, characterization and gas permeation studies”, Int. J. Hydrogen Energy. 2015, Vol. 40, pp. 5653-5663;
M.A. Llosa et al., “Composite-alumina-carbon molecular sieve membranes prepared from Novolac resin and boehmite. Part II: Effect of the carbonization temperature on the gas permeation properties”, Int. J. Hydrogen Energy. 2015, Vol. 40, pp. 3485-3496;
M. Texeira et al., “Boehmite-phenolic resin carbon molecular sieve membranes-Permeation and adsorption studies” Chem. Eng. Res. Des. 2014, vol. 92, no. 11, pp. 2668-2680;
L. Li, C. Song, H. Jiang, J. Qiu, and T. Wang, “Preparation and gas separation performance of supported carbon membranes with ordered mesoporous carbon interlayer,” J. Memb. Sci., vol. 450, pp. 469-477, January 2014;
A. K. Itta, H. H. Tseng, and M. Y. Wey, “Fabrication and characterization of PPO/PVP blend carbon molecular sieve membranes for H₂/N₂ and H₂/CH₄ separation,” J. Memb. Sci., vol. 372, no. 1-2, pp. 387-395, April 2011.

What is claimed is:

1. A supported carbon molecular sieve membrane having aluminum atomically distributed in it, which means that the aluminum is incorporated in the carbon molecular sieve membrane in the form of single atom; wherein:
the aluminum is present in an amount of equal to or lower than 15 wt. % of the carbon molecular sieve membrane;
the membrane comprises a pore size distribution in which at least 70% of the pores have a pore size from 0.25 to 0.7 nm, measured by perm-porosimetry;
the carbon content of the carbon molecular sieve membrane is from 75 wt. % to 95 wt. %, the oxygen content is from 2.5 wt. % to 8 wt. %, and the hydrogen content is from 1.5 wt. % to 6% wt. %; and
which is obtainable by dip-coating a support with a solution comprising a phenol formaldehyde-resin and aluminum ions in the form of an appropriate salt or complex as metal precursor, followed by carbonization, wherein the appropriate salt or complex has an organic anion or an organic neutral ligand.

2. The supported carbon molecular sieve membrane according to claim 1, wherein the membrane comprises a pore size distribution in which at least 60% of the pores have a pore size from 0.25 to 0.6 nm.

3. The supported carbon molecular sieve membrane according to claim 2, wherein at least 85% of the pores have a pore size from 0.25 to 0.6 nm.

4. The supported carbon molecular sieve membrane according to claim 1, wherein the support of the carbon molecular sieve membrane is a porous alumina support.

5. The supported carbon molecular sieve membrane according to claim 1, wherein the phenol formaldehyde resin is a synthetic phenol formaldehyde resin.

6. The supported carbon molecular sieve membrane according to claim 1, wherein the aluminum ions are in the form of aluminum acetylacetonate.

7. The supported carbon molecular sieve membrane according to claim 1, wherein the aluminum is present in an amount of 1 wt. % to 11 wt % of the carbon molecular sieve membrane.

8. The supported carbon molecular sieve membrane according to claim 7, wherein the aluminum is present in an amount of 1 wt. % to 9 wt. % of the carbon molecular sieve membrane.

9. The supported carbon molecular sieve membrane according to claim 8, wherein the aluminum is present in an amount of 7 wt. % to 9 wt. % of the carbon molecular sieve.

10. A process for the preparation of a supported carbon molecular sieve membrane as defined in claim 1, comprising:
a) providing a porous support;
b) providing a coating solution comprising a phenol formaldehyde resin as carbon precursor, a non-aqueous solvent, formaldehyde, an acid, and aluminum ion in the form of an appropriate salt or complex as metal precursor;
c) dipping at least once the porous alumina support in the solution of step b);
d) optionally, drying the coated support bearing aluminum of step c);
e) heating the dried support of step d) to a final pyrolysis temperature and non-oxidizing atmosphere sufficient to form the supported carbon sieve membrane containing the aluminum;
f) cooling the supported carbon sieve membrane of step e) to room temperature; and
wherein the appropriate salt or complex has an organic anion or an organic neutral ligand.

11. The process according to claim 10, wherein the pyrolysis temperature is from 350° C. to 1100° C.° C. and is carried out under a non-oxidant atmosphere or vacuum.

12. A process for the separation of a gas molecule which is H₂ from a gas mixture of the gas molecule and at least one other gas molecule, the process comprising:
a) providing a supported carbon molecular sieve membrane as defined in claim 1;
b) providing a gas mixture comprising at least two gases; and
c) feeding the gas mixture to the supported carbon molecular sieve membrane at a temperature from −80° C. to 300° C. in order to get a retentate stream having a decreased concentration of the gas molecule and a permeate stream having an increased concentration of the gas molecule.

13. The process according to claim 12, wherein the gas mixture comprising at least two gases is selected from the group consisting of H₂/CH₄; H₂/N₂; H₂/CO₂.

14. A method for H₂ recovery from natural gas grids, H₂ production from biomass, for solvent dehydration, for obtaining oxygen-enriched air, or for dehydrogenation of methylcyclohexane, comprising using a supported CMSM membrane as defined in claim 1.

15. A method for conducting a process selected from the group consisting of: a process comprising reacting CO₂ and H₂ to produce CH₄; a process comprising reacting alcohols with carboxylic acids to yield esters; preparing biodiesel and bio lubricants; a process for producing methanol from CO₂ and H₂; process for producing dimethyl ether by methanol dehydration or by direct synthesis from CO₂ and H₂; and process comprising reacting CO₂ and methanol to yield dimethyl carbonate, which comprises the use of a supported CMSM as defined in claim 1 as a catalytic membrane reactor or part of a catalytic membrane reactor.

16. The supported carbon molecular sieve membrane according to claim 3, wherein the support of the carbon molecular sieve membrane is a porous alumina support.

17. The supported carbon molecular sieve membrane according to claim 4, wherein the phenol formaldehyde resin is a synthetic phenol formaldehyde resin.

18. The supported carbon molecular sieve membrane according to claim 5, wherein the aluminum ions are in the form of aluminum acetylacetonate.
